(19) United States
(12) Patent Application Publication
(10) Pub. No.: US 2012/0220686 A1
(43) Pub. Date: Aug. 30, 2012

(54) PRESSURE-SENSITIVE ADHESIVE

(75) Inventors: Sabine Thormeier, Hamburg (DE); Franziska Czerwonatis, Hamburg (DE); Christian Kreft, Hamburg (DE); Axel Burmeister, Buchholz (DE); Stephan Buenz, Ostrohe (DE)

(73) Assignee: tesa SE, Hamburg (DE)

(21) Appl. No.: 13/057,391

(22) PCT Filed: Aug. 5, 2009
(86) PCT No.: PCT/EP2009/060137

§ 371 Date: Dec. 6, 2011

(30) Foreign Application Priority Data
Aug. 15, 2008 (DE) 10 2008 037 845.3

(51) Int. Cl. C09J 133/10

(52) U.S. Cl. 522/182; 524/523

(57) ABSTRACT

Pressure-sensitive adhesive comprising at least one polyisobutylene, at least one (meth)acrylate polymer or copolymer, and optionally additives, the proportion of polyisobutylene being at least 10% by weight of the pressure-sensitive adhesive.

The invention relates to a pressure-sensitive adhesive, method for producing it, and uses of the pressure-sensitive adhesive.

Pressure-sensitive adhesives (PSAs) comprising polyisobutylene are known from the prior art. The properties of polyisobutylene vary in dependence on its molecular weight.

All polyisobutylenes have a rubberlike glass transition point of about −65° C. The aging and weathering behavior of polyisobutylenes, however, is substantially more stable than that of natural rubber, since polyisobutylenes have a saturated character.

As in the case of natural rubber, polyisobutylenes are generally blended with tackifying resins, in which case mixtures of polyisobutylenes of high and low molecular weight are preferably employed. PSAs based on polyisobutylenes generally have similar technical properties to natural rubber PSAs. The aging stability of PSAs based on polyisobutylenes, on the other hand, is more like that of acrylate PSAs.

Apart from the tendency of PSAs based on high molecular weight polyisobutylenes toward disadvantageous flow behavior at room temperature and temperatures below it (cold flow), the absence of the possibility for crosslinking by means of electron beams is particularly disadvantageous. Crosslinking of polymers by means of electron beams, referred to below as electron beam curing (EBC), ensures an increase in the molecular weight of the PSA components to be crosslinked, and hence ensures strong cohesion between the components without disadvantageously influencing the tack and the detachment resistance of the PSA. On account of their saturated character, polyisobutylenes cannot be crosslinked by electron beam curing, and this results in deficient cohesion of PSAs based on polyisobutylenes, particularly at temperatures below room temperatures.

It is an object of the invention to eliminate the disadvantages according to the prior art. The intention in particular is to specify a PSA based on polyisobutylenes which, particularly at temperatures below room temperature, exhibits excellent flow behavior and high cohesion. A further intention is to specify methods for producing such a PSA, and uses of this PSA.

This object is achieved through the features of claims 1, 15, 19, and 20. Useful embodiments of the inventions are apparent from the features of claims 2 to 14 and 16 to 18.

Provided in accordance with the invention is a pressure-sensitive adhesive which comprises at least one polyisobutylene, at least one (meth)acrylate polymer or copolymer, and optionally additives, the fraction of the polyisobutylene in the pressure-sensitive adhesive being at least 10% by weight, based on the weight of the pressure-sensitive adhesive.

The PSAs of the invention are notable relative to acrylate PSAs for high bond strength even at low temperatures. This applies particularly in respect of temperatures below room temperature, such as temperatures of 5° C. or less, for example. At low temperatures, acrylate PSAs lose bond strength, while the bond strength of the PSA of the invention in fact rises. This effect is attributable to the flexibility of the polyisobutylene, which is based in turn on its very low glass transition point (Tg). The high bond strength of the PSAs of the invention even at low temperatures makes them suitable particularly for applications in the outdoor area.

Furthermore, the PSA of the invention exhibits a comparatively consistent bond strength over long storage periods on substrates (long-term bonds). With acrylate PSAs, in contrast, there is an increase in the bond strength in long-term bonds. This is disadvantageous when an adhesive tape comprising these PSAs is to be removed again. The PSA of the invention, on the other hand, ensures that an adhesive tape featuring such a PSA possesses a substantially unchanged bond strength, and this facilitates targeted selection of the PSA for a particular adhesive-bonding application.

Furthermore, the PSAs of the invention possess high aging resistance. This is attributable to the saturated character both of the polyisobutylene component and of the (meth)acrylate polymer or copolymer component.

The PSAs of the invention, moreover, possess good processing properties even at high temperatures, which is attributable to their viscosity, and a high bonding strength even to rough substrates.

The fraction of the polyisobutylene in the pressure-sensitive adhesive is preferably at least 25% by weight, more preferably at least more 45% by weight, even more preferably at least 60% by weight, based each case on the weight of the pressure-sensitive adhesive.

The fraction of the additives in the pressure-sensitive adhesive is preferably between 0% and 10% by weight, based on the weight of the pressure-sensitive adhesive.

In one preferred embodiment, the weight ratio of polyisobutylene to (meth)acrylate polymer or copolymer is between 5:1 and 1:5, more preferably between 2:1 and 1:2, more preferably still between 1.5:1 and 1:1.5, based on the total weight of polyisobutylene to poly(meth)acrylate polymer or copolymer in the pressure-sensitive adhesive.

In one embodiment the pressure-sensitive adhesive of the invention comprises, based on the weight of the pressure-sensitive adhesive,

(a) 40% to 60% by weight of polyisobutylene;
(b) 60% to 40% by weight of (meth)acrylate polymer or copolymer; and
(c) 0% to 10% by weight of additives.

In a second embodiment the pressure-sensitive adhesive of the invention comprises, based on the weight of the pressure-sensitive adhesive,

(a) 45% to 55% by weight of polyisobutylene;
(b) 55% to 45% by weight of (meth)acrylate polymer or copolymer; and
(c) 0% to 5% by weight of additives.

In a further embodiment the pressure-sensitive adhesive of the invention comprises, based on the weight of the pressure-sensitive adhesive,

(a) 45% to 55% by weight of polyisobutylene;
(b) 55% to 45% by weight of (meth)acrylate polymer or copolymer; and
(c) 0% by weight of additives.

It is preferred for the pressure-sensitive adhesive of the invention not to contain any tackifying resins.

In one preferred embodiment the pressure-sensitive adhesive of the invention has been subjected to electron beam curing.

The polyisobutylene is preferably a high molecular weight polyisobutylene. The polyisobutylene preferably has a weight-average molecular weight of greater than or equal to 500 000, more preferably greater than or equal to 800 000, even more preferably greater than 1 000 000.

Mixtures of polyisobutylenes having different molecular weights and molar mass distributions may be used.

The adhesive activity of the PSA derives substantially from the mixture of polyisobutylene and (meth)acrylate polymer or copolymer, and so there is no need for any tackifying resin to be added to the PSA.

As (meth)acrylate polymer or copolymer it is possible to use all polymers and/or copolymers which are used for the production of acrylate PSAs. The (meth)acrylate polymer or copolymer may be prepared from, for example, acrylic esters and/or methacrylic esters of the formula CH₂═CH(R₁)(COOR₂), where R₁ is H and/or CH₃ and R₂ is H and/or alkyl chains having 1 to 30 carbon atoms, 4 to 14 carbon atoms, preferably 4 to 9 carbon atoms. Specific examples, without wishing to be restricted by this enumeration, are n-butyl acrylate, n-pentyl acrylate, n-hexyl acrylate, n-heptyl acrylate, n-octyl acrylate, n-nonyl acrylate, lauryl acrylate, stearyl acrylate, behenyl acrylate, and the branched isomers of these, such as 2-ethylhexyl acrylate, for example.

As additives it is possible to admix the PSA with any of the additives known to the skilled person for producing polyisobutylene PSAs and acrylate PSAs, examples being fillers, pigments, rheological additives, adhesion promoter additives, plasticizers, elastomers, aging inhibitors (antioxidants), light stabilizers, UV absorbers, and other auxiliaries and adjuvants, such as drying agents (for example, molecular sieve zeolites, calcium oxide), flow and flow-control agents, wetting agents (surfactants) or catalysts, for example.

As fillers it is possible to use all finely ground solid adjuvants such as, for example, chalk, magnesium carbonate, zinc carbonate, kaolin, barium sulfate, titanium dioxide or calcium oxide. Further examples are talc, mica, silica, silicates or zinc oxide. Mixtures of the substances stated may also be employed.

The pigments used may be organic or inorganic in nature. All kinds of organic or inorganic color pigments are suitable, examples being white pigments such as titanium dioxide, for instance, for improving the light stability and UV stability, and also metal pigments.

Examples of rheological additives are fumed silicas, phyllosilicates (bentonites), high molecular weight polyamide powders or castor oil derivative powders.

Adhesive promoter additives may be, for example, substances from the groups of the polyamides, epoxides or silanes.

Examples of plasticizers are phthalic esters, trimellitic esters, phosphoric esters, esters of adipic acid, and other acyclic dicarboxylic esters, fatty acid esters, hydroxycarboxylic esters, alkylsulfonic esters of phenol, aliphatic, cycloaliphatic, and aromatic mineral oils, hydrocarbons, liquid or semi solid rubbers (for example, nitrile rubbers or polyisoprene rubbers), liquid or semi solid polymers of butene and/or isobutene, acrylic esters, polyvinyl ethers, liquid resins and plasticizer resins based on the raw materials which are also the basis for tackifier resins, wool wax and other waxes, silicones, and also polymer plasticizers such as, for instance, polyesters or polyurethanes.

Suitable resins are all natural and synthetic resins, such as, for instance, rosin derivatives (derivatives formed, for example, by disproportionation, hydrogenation or esterification), coumarone-indene resins and polyterpene resins, aliphatic or aromatic hydrocarbon resins (C-5, C-9, (C-5)₂ resins), mixed C-5/C-9 resins, hydrogenated and part-hydrogenated derivatives of the stated types, resins of styrene or methyl styrene, and also terpene-phenolic resins and others, as listed in Ullmanns Enzyklopädie der technischen Chemie (4th edn.), volume 12, pp. 525-555, Weinheim. By means of the resins it is possible for the technical properties of the adhesion promoters of the invention to be adjusted and controlled. The resins may serve, furthermore, as phase mediators.

Suitable elastomers are, for example, EPDM rubber or EPM rubber, polyisobutylene, butyl rubber, ethylene-vinyl acetate, hydrogenated block copolymers of dienes (for example by hydrogenation of SBR, cSBR, BAN, NBR, SBS, SIS or IR; such polymers are known, for example, as SEPS and SEBS) or acrylate copolymers such as ACM.

The formulating of the adhesive of the invention with further constituents, such as fillers and plasticizers, for example, is likewise prior art.

The PSAs of the invention can be crosslinked by means of electron beam curing (EBC). Typical irradiation equipment that may be employed includes linear cathodes systems, scanner systems or segmented cathode systems, where electron beam accelerators are used. A comprehensive description of the state of the art and the most important process parameters are found in Skelhorne, Electron Beam Processing, in Chemistry and Technology of UV and EB formulation for Coatings, Inks and Paints, vol. 1, 1991, SITA, London. The typical acceleration voltages are situated in the range between 50 kV and 500 kV, preferably 80 kV and 300 kV. The scatter doses employed range between 5 to 150 kGy, more particularly between 20 and 100 kGy.

The effect of the electron beam curing is to crosslink the (meth)acrylate polymer or copolymer in the PSA of the invention. This produces a distinct improvement in the temperature stability of the PSA of the invention, as has been shown by accelerated temperature stability tests (SAFT).

The invention relates, finally, to the use of the above-described adhesives for a single-sided or double-sided adhesive tape composed of at least one carrier and a layer of a PSA.

Carrier materials used for the PSA of the invention, for adhesive tapes, for example, are the materials that are customary and familiar to the skilled person, such as films (polyester, PET, PE, PP, BOPP, PVC, polyimide), nonwovens, foams, woven fabrics and woven fabric films, and also release paper (glassine, HDPE, LDPE). Another embodiment uses the PSA to produce masking tapes. This enumeration is not conclusive.

In accordance with the invention, therefore, a method is additionally provided for producing the pressure-sensitive adhesive of the invention, and comprises the following steps:

(a) providing the polyisobutylene, the (meth)acrylate polymer or copolymer, and optionally the additives; and
(b) mixing the components provided in step (a), to give a homogeneous mixture; and
(c) shaping the mixture obtained in step (b).

Step (b) can be carried out in a suitable mixing assembly, such as a planetary roller extruder or twin-screw extruder, for example. Preference is given to an extruder temperature of more than 130° C., more preferably 130° C., and a rotary speed of the extruder in mixing or conveying operation of more than 50 revolutions/min, more preferably 75 to 100 revolutions/min and usefully the PRE temperature profile is selected (heat-treatment circle 1, 2 and 3).

The mixtures obtained in step (b), also referred to below as blends, can then be shaped by means of a roll applicator to form a pressure-sensitively adhesive layer. For this purpose the mixture is applied usefully with layer thicknesses of 15 to 200 g/m², preferably 50 g/m², to a carrier, preferably paper or a film.

The mixture is subjected preferably to electron beam curing (EBC). This method step is usefully carried out subsequently to the shaping of the mixture.

The invention is elucidated in more detail below, with reference to the drawings, and using examples. In the drawings,

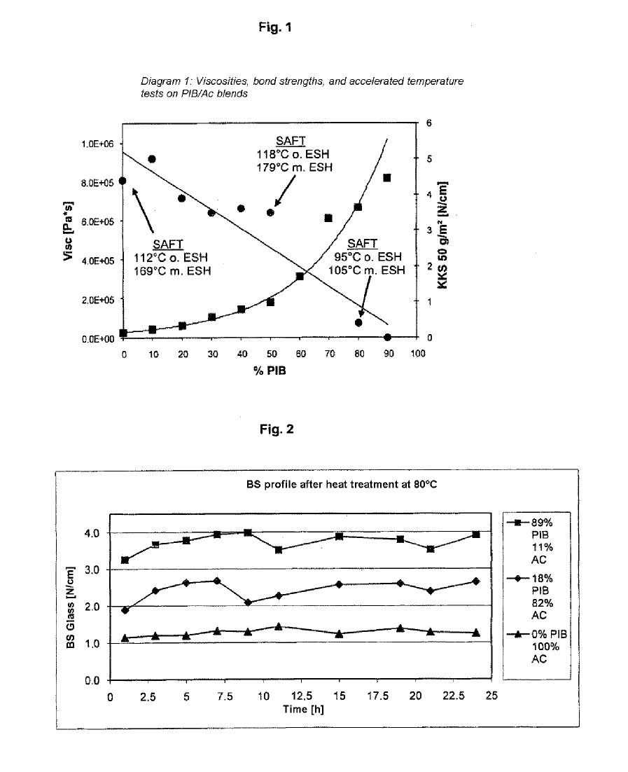

FIG. 1 shows a diagram which shows the viscosity, bond strength, and results of accelerated temperature tests (SAFT) on exemplary PSAs of the invention in comparison to acrylate PSAs; and

FIG. 2 shows a diagram which shows the change in bond strength over time of, for example, PSAs of the invention in comparison to acrylate PSAs, after a temperature at 80° C.

### EXAMPLES

The PSAs of the invention as indicated in table 1 were produced. None of these PSAs contained additives.

The PSAs were produced by mixing a high molecular weight, rubberlike polyisobutylene (Oppanol B 100, weight-average molecular weight 1 100 000) with an aqueous, weakly ammoniacal acrylate copolymer dispersion (Primal PS 83 D) in a planetary roller extruder (PRE temperature profile (heating circles 1, 2 and 3)) at 130° C. The rotary speed of the extruder in mixing and conveying operation was 75-100 rpm. The PSAs of the invention thus obtained were shaped via a roll applicator to form a pressure-sensitively adhesive film of 50 g/m² on a film carrier.

TABLE 1

| | Fraction of | Fraction of (meth)acrylate |
|---|---|---|
| | polyisobutylene | polymer or copolymer |
| Code | [% by weight] | [% by weight] |
| NB-05-28 | 95 | 5 |
| NB-05-29 | 89 | 11 |
| NB-05-30 | 82 | 18 |
| NB-05-31 | 75 | 25 |
| NB-05-32 | 67 | 33 |
| NB-05-33 | 57 | 43 |
| NB-05-34 | 46 | 54 |
| NB-05-35 | 33 | 67 |
| NB-05-36 | 18 | 82 |

The diagram shown in FIG. 1 sets out the viscosities (Visc), the bond strengths to steel (BSS), and, for selected examples, the accelerated temperature resistances (SAFT) of PSAs of the invention, identified in FIG. 1 as PIB/acrylate mixtures. The abscissa shows the weight fraction of the acrylic copolymer (from 0 to 100 percent by weight). The meanings of the abbreviations used are as follows:
Ac Acrylate copolymer
EBC Electron beam curing
BSS 50 Bond strength of an adhesive tape 50 mm wide on a steel plate
w. with
wo. without
PIB Polyisobutylene
SAFT Accelerated temperature resistance as per the Shear Adhesion Failure Test
Visc Viscosity

The curve which drops linearly shows the viscosity of the PSAs, while the curve which ascends parabolically shows the bond strength of the PSAs. It is apparent that, in the case of preferred mixing proportions of the PSAs of the invention, bond strengths of 3 to 4 N/cm can be achieved even without any addition of resin. Bond strengths of this kind are customary, for example, in the area of the applications of masking tapes.

By means of EBC crosslinking of the acrylate it is possible, furthermore, to achieve a significant improvement in the temperature resistance of the PSAs of the invention. This is shown by the accelerated temperature resistance test (SAFT).

Table 2 shows, for various PSAs, the bond strength on steel at room temperature (RT), 5° C., and 14 days following application and storage, at room temperature.

TABLE 2
Bond strength on steel of inventive PSAs

| Ac contents [% by | | | 14 d after |
|---|---|---|---|
| weight] | RT (23° C.) | 5° C. | application, RT |
| 100* | 5.0 | 4.1 | 8.8 |
| 80 | 5.0 | 5.0 | 6.7 |
| 50 | 3.8 | 4.6 | 5.5 |
| 30 | 3.5 | 5.6 | 5.3 |

*Comparative example

Evident from table 2 is a change in the bond strength after application and under the effect of temperature, respectively. The bond strength of the PSAs on substrates such as steel after a storage time depends on the selected weight ratio of polyisobutylene and acrylate copolymer. Whereas the pure acrylate PSA exhibits a significantly increasing bond strength, the bond strength remains at a substantially constant level in the case of the PSAs of the invention with a weight ratio of polyisobutylene and acrylate copolymer of 1 to 1. This is evidence of the advantages of the PSAs of the invention in long-term bonding with subsequent desired removal of the adhesive tape bearing the PSA of the invention.

It is further apparent that the bond strength at low temperatures, as in the case of bonds in the outdoor area, for example, can be influenced by the weight ratio of polyisobutylene and acrylate copolymer. Whereas pure acrylate PSAs lose bond strength at low temperatures, it is possible with the PSAs of the invention, depending on polyisobutylene content, for the bond strengths in fact to rise at low temperatures, owing to the flexibility of the polyisobutylene on account of its characteristic very low glass transition point (Tg).

FIG. 2 shows the aging resistance of the PSAs of the invention. It is apparent that the PSAs of the invention (89% by weight polyisobutylene/11% by weight acrylate copolymer; 18% by weight polyisobutylene/82% by weight acrylate copolymer) exhibit advantages over pure acrylate PSAs. On account of the saturated character both of the polyisobutylene and of the acrylate copolymer, the aging resistance of the PSAs of the invention is relatively constant even over a long period of time. This applies over a wide range of polyisobutylene/acrylate copolymer weight ratio.

The meanings of the abbreviations used in FIG. 2 are as follows:

AC Acrylate copolymer
BS glass Bond strength to glass
PIB Polyisobutylene

1. A pressure-sensitive adhesive comprising at least one polyisobutylene, at least one (meth)acrylate polymer or copolymer, and optionally additives, the fraction of polyisobutylene in the pressure-sensitive adhesive being at least 10% by weight, based on the weight of the pressure-sensitive adhesive.

2. The pressure-sensitive adhesive of claim 1, wherein the amount of polyisobutylene in the pressure-sensitive adhesive is at least 25% by weight, based on the weight of the pressure-sensitive adhesive.

3. The pressure-sensitive adhesive of claim 2, wherein the amount of polyisobutylene in the pressure-sensitive adhesive is at least 45% by weight, based on the weight of the pressure-sensitive adhesive.

4. The pressure-sensitive adhesive of claim 1, wherein the amount of additives in the pressure-sensitive adhesive is between 0% and 10% by weight, based on the weight of the pressure-sensitive adhesive.

5. The pressure-sensitive adhesive of claim 1, wherein the weight ratio of polyisobutylene to (meth)acrylate polymer or copolymer is between 5:1 and 1:5, based on the total weight of polyisobutylene to poly(meth)acrylate polymer or copolymer in the pressure-sensitive adhesive.

6. The pressure-sensitive adhesive of claim 5, wherein the weight ratio of polyisobutylene to (meth)acrylate polymer or copolymer is between 2:1 and 1:2, based on the total weight of polyisobutylene to (meth)acrylate polymer or copolymer in the pressure-sensitive adhesive.

7. The pressure-sensitive adhesive of claim 6, wherein the weight ratio of polyisobutylene to (meth)acrylate polymer or copolymer is between 1.5:1 and 1:1.5, based on the total weight of polyisobutylene to (meth)acrylate polymer or copolymer in the pressure-sensitive adhesive.

8. The pressure-sensitive adhesive of claim 1, comprising based on the weight of the pressure-sensitive adhesive,
(a) 40% to 60% by weight of polyisobutylene;
(b) 60% to 40% by weight of (meth)acrylate polymer or copolymer; and
(c) 0% to 10% by weight of additives.

9. The pressure-sensitive adhesive of claim 8, comprising based on the weight of the pressure-sensitive adhesive,
(a) 45% to 55% by weight of polyisobutylene;
(b) 55% to 45% by weight of (meth)acrylate polymer or copolymer; and
(c) 0% to 5% by weight of additives.

10. The pressure-sensitive adhesive of claim 9, comprising based on the weight of the pressure-sensitive adhesive,
(a) 45% to 55% by weight of polyisobutylene;
(b) 55% to 45% by weight of (meth)acrylate polymer or copolymer; and
(c) 0% by weight of additives.

11. The pressure-sensitive adhesive of of claim 1 cured by electron beam curing.

12. The pressure-sensitive adhesive of claim 1, wherein said polyisobutylene has a weight-average molecular weight of greater than or equal to 500 000.

13. The pressure-sensitive adhesive of claim 12, wherein said polyisobutylene has a weight-average molecular weight of greater than or equal to 800 000.

14. The pressure-sensitive adhesive of claim 13, wherein said polyisobutylene has a weight-average molecular weight of greater than or equal to 1 000 000.

15. A method for producing the pressure-sensitive adhesive of following claim 1, comprising the steps of
(a) providing the polyisobutylene, the (meth)acrylate polymer or copolymer, and optionally the additives; and
(b) mixing the components provided in step (a), to give a homogeneous mixture; and
(c) shaping the mixture obtained in step (b).

16. The method of claim 15, wherein step (c) comprises applying said mixture to a carrier and in the process shaping it to a layer.

17. The method of claim 15 wherein the mixture is subjected to an electron beam treatment.

18. The method of claim 17, wherein the electron beam treatment is carried out subsequent to the shaping of the mixture.

19. A pressure-sensitive adhesive tape comprising the pressure-sensitive adhesive of claim 1.

20. A masking tape comprising the pressure-sensitive adhesive of claim 1.

21. The method of claim 16 wherein the mixture is subjected to an electron beam treatment.
